(19) United States
(12) Patent Application Publication
(10) Pub. No.: US 2023/0152091 A1
(43) Pub. Date: May 18, 2023

(54) METHOD AND DEVICE FOR CARRYING OUT MINE SURVEYING OPERATIONS

(71) Applicant: Kanagat Samarovich ASHIRBEKOV, Shakhtinsk (KZ)

(72) Inventor: Kanagat Samarovich ASHIRBEKOV, Shakhtinsk (KZ)

(21) Appl. No.: 17/913,467

(22) PCT Filed: Jun. 9, 2021
(86) PCT No.: PCT/KZ2021/000014

§ 371 Date: Feb. 2, 2023

(30) Foreign Application Priority Data
Apr. 20, 2020 (KZ) 2020/0191.1

(51) Int. Cl. G01C 11/02; G01S 19/49

(52) U.S. Cl. CPC G01C 11/025; G01S 19/49

(57) ABSTRACT

The present invention relates to mine surveying. The proposed invention makes it possible to carry out geodetic mine surveying operations with unprecedented ease. The invention is a reliable primary device for carrying out the majority of geodetic mine surveying operations and will significantly reduce the amount of time needed to carry out geodetic mine surveying operations while requiring only a small number of specialists.

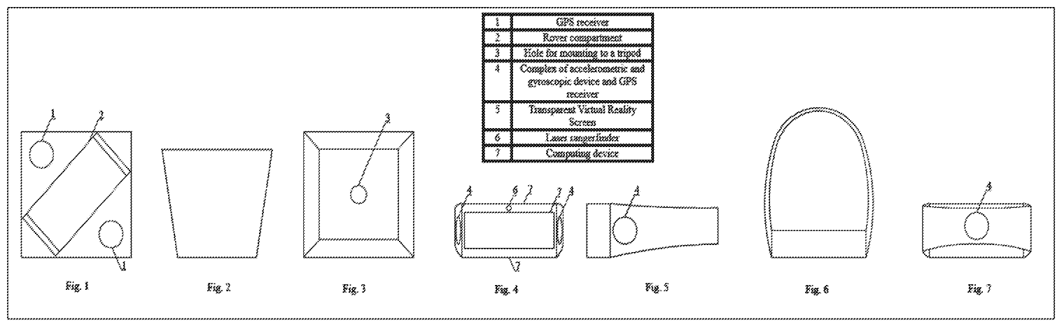

The present invention relates to surveying.

There is a device that can measure a cross-section of the excavated space, consisting of a point light source located at the upper end of the rail, with which the light source is sequentially circled along a controlled cross-section (A. A. Trofimov et al. Photogrammetric method for controlling the cross-section of large-sized mine workings./Collection of scientific papers about advanced technologies and technical and economic policy of field development in the XXI century.—Gatsmiz, Krasnoyarsk,—p. 67)

The disadvantage of this device is the need to use an additional device for measuring distances to the illuminated point on the contour of the excavated space.

The closest in technical essence and the achieved result to the claimed is a device for measuring sections of mine workings, consisting of a vertical rack, a plate fixed in the upper part of the plates perpendicular to its vertical axis of the optical sight, as well as a round level (Nikolaev N. N. et al. Measuring sections of preparatory and cleaning mine workings using the device “Pulsed light profile—FS6”/Collection. Methods and techniques of surveying work. Proceedings of VNIMI, No. 90, 1973, pp. 97-102).

The disadvantages of this device are, firstly, the complexity of its orientation along the projected section of the excavated space, especially in cases where the surveying direction of the survey does not coincide with the direction of the longitudinal axis of the excavated space (for example, if there are ore outlets or other objects in the excavated space that interfere with the combination of the surveying direction of the survey with the longitudinal axis of the excavated space)—this reduces the accuracy of drawing the contours of the excavated space on the surveying documentation and the accuracy of calculating the volumes of excavated space, since the perpendicular plane of the plates relative to the longitudinal axis of the excavated space is not instrumentally controlled; secondly, the need to use an additional device for measuring distances to the illuminated contour of the excavated space.

At the moment, total stations and GNSS equipment are used for surveying in most cases.

The total station is a universal tool widely used in engineering and geodetic surveys. With its help, detailed maps of the terrain are compiled with an accurate definition of heights and relief differences, the location of natural and artificial objects. The first total station in its modern form was created in Sweden about 25 years ago. This device appeared as a result of merging the functions of a theodolite and a rangefinder in one device.

Satellite receiver (also known as GNSS receiver) is a radio receiving device for determining the geographical coordinates of the current location of the receiver antenna, based on data on the time delays of the arrival of radio signals emitted by navigation system satellites.

The proposed invention makes it possible to carry out surveying and geodetic work with unprecedented ease.

The device consists of:
head-mounted virtual reality display with transparent display;
set of GNSS trackers;
MEMS gyroscopes or IFOG gyroscopes;
MEMS accelerometers;
GNSS database;
laser rangefinder;
central processing unit.

Through the GNSS database and GPS trackers, the device calculates its exact location. The multiplicity of GNSS trackers will allow you to calculate the direction of the device operator's gaze. Alternatively, it is possible to calculate the direction of the device operator's gaze through gyroscopic and accelerometric systems. If there is no access to GNSS satellites, for example, under the surface in a mine, the exact location of the device is calculated through MEMS gyroscopes or IFOG gyroscopes, and MEMS accelerometers.

The device consists of two parts: a fixed GNSS base and a mobile Rover, which will be controlled by the operator. The rover consists of a head-mounted virtual reality display with a transparent display, a set of GNSS trackers, MEMS gyroscopes or IFOG gyroscopes, MEMS accelerometers, a laser rangefinder and a CPU. GNSS base has several GPS trackers for information about the location of the base in space. There is a special compartment for the Rover on the GNSS base. When placing the Rover in a special compartment, the Rover calculates its exact coordinates.

The essence of the device is to visualize the ongoing surveying work. With such surveying and geodetic works as projecting geodetic objects in real life, the central processor will show through the head-mounted display the location of the points that need to be projected in real life, based on data on the exact location of the operator in space, thereby greatly reducing the time required for work. With such surveying and geodetic works as geodetic survey work, the operator will need to enter the height from the ground to the GNSS trackers into the device, then stand over the object being filmed and take the exact location. If the object being taken is difficult to access, the operator will use a laser rangefinder in non-reflective mode. The device will read the distance to the object and the direction of the laser rangefinder to calculate the exact coordinates of the point being taken. The device needs only one operator to function.

Thus, the invention is a reliable main device for carrying out most surveying and geodetic works, it will greatly reduce the required time for conducting surveying and geodetic works and will need a small number of specialists.

The usage cycle consists of the following steps:
1. Turn on the GNSS database and calculate the exact location of the GNSS database.
2. Turn on and prepare the Rover to calculate the coordinates.
a) If it is possible to connect to satellites: enable GNSS trackers and calculate coordinates through the received data. Turn on the gyroscopic and accelerometric systems and calculate the direction of view through the received data.
b) If it is not possible to connect to satellites: install the Rover in a special compartment and calculate the exact location of the Rover, turn on the gyroscopic and accelerometric systems. From that point onwards data on the location of the Rover will be obtained from gyroscopic and accelerometric systems. Data on the direction of the operator's gaze will be obtained from the gyroscopic and accelerometric systems.
3. Put the Rover on the operator.
4. Perform the required surveying and geodetic works.
5. At the end of the work, turn off the Rover and GNSS base.

The device has sets of electric batteries. The operator at work will be required to have spare electric batteries in case of electric batteries in the device running out.

Method of conducting surveying work:

Let's consider the method of conducting surveying work on the example of a typical surveying task in open-pit mining—to set the boundaries of the block allocated for explosion. To do this, the exact coordinates of characteristic points in space are taken from the mining plan.

To get started, you need to turn on the GNSS Database and prepare it for work, namely: calculate the coordinates of the location of the GNSS Database. Next, you need to turn on the GNSS Rover and calculate the exact coordinates of the GNSS Rover location. This is done in one of the two ways described in the device usage cycle [usage cycle 2.a) and 2.b)].

With the GNSS Base and GNSS Rover connected, you can start working. The operator needs to put the rover on his head. When entering coordinates of the earlier mentioned points, the Rover will project the exact position of the characteristic points in space onto a head-mounted virtual reality display with a transparent display. Thanks to the transparency of the display, the operator will be able to see both the actual situation and the projection of characteristic points on the actual situation. The ability to see the exact location of characteristic points will allow the operator to quickly find these points and mark them in space using wooden stakes or other means. This ends the surveying task of setting the boundaries of the block allocated for the explosion. The speed of finding characteristic points by means of projection on a transparent display will save the company the time of a specialist, which will lead to higher productivity of the said specialist.

1. A device for conducting surveying work, which is made distinct by the fact that it is a fixed GNSS base and a mobile ‘Rover’ consisting of a head-mounted virtual reality display with a transparent display with the ability to display data for surveying and geodetic works, and made with the ability to track the location of the device and the direction of the operator's gaze, while in the absence of a satellite connection The Rover navigation system uses a system of gyroscopes and accelerometers to find the exact location.

2. The method of conducting surveying work, which is made distinct by the fact that the device is used according to p. 1, using virtual/augmented reality, satellite navigation system to find the exact location, while, in the absence of a connection with the satellite navigation system, the rover uses a system of gyroscopes and accelerometers to find the exact location during surveying and geodetic works, in addition, the rover tracks not only the location of the device, but also the direction of the operator's gaze, The rover shows the data necessary for surveying and geodetic works through a transparent virtual reality display.
